(19) United States
(12) Patent Application Publication
(10) Pub. No.: US 2026/0160861 A1
(43) Pub. Date: Jun. 11, 2026

(54) METHOD OF OBJECT CLASSIFICATION, ENVIRONMENTAL SENSOR AND VEHICLE

(71) Applicant: AUMOVIO Autonomous Mobility Germany GmbH, Ingolstadt (DE)

(72) Inventor: Philippe Dintzer, Kressbronn (DE)

(73) Assignee: AUMOVIO Autonomous Mobility Germany GmbH, Ingolstadt (DE)

(21) Appl. No.: 19/386,898

(22) Filed: Nov. 12, 2025

(30) Foreign Application Priority Data
Dec. 6, 2024 (DE) 102024211691.2

(51) Int. Cl. G01S 7/41; G01S 13/58

(52) U.S. Cl. CPC G01S 7/415; G01S 13/58

(57) ABSTRACT

A method for object classification for an environmental sensor for environmental detection, in particular for a radar sensor. The environmental sensor emits signals which are reflected at objects and are received again by the environmental sensor. The object is a target vehicle, on the basis of which signals a main speed of the target vehicle is determined, and speeds are determined for signals reflected at at least one wheel rim of the target vehicle. A dispersion is determined on the basis of the speeds resulting from the deviation of the determined speeds from the main vehicle speed, and a ratio of wheel rim diameter to wheel diameter is determined on the basis of the dispersion. The ratio is used for the object classification of the target vehicle.

### CROSS REFERENCE TO RELATED APPLICATIONS

This application claims priority to German Application No. 10 2024 211 691.2, filed Dec. 6, 2024, the contents of such application being incorporated by reference herein.

### FIELD OF THE INVENTION

The present invention relates to a method for object classification for an environmental sensor, an environmental sensor, in particular a radar sensor, for a vehicle and a vehicle that has an environmental sensor according to the invention.

### BACKGROUND OF THE INVENTION

Modern means of transport, such as motor vehicles or motorcycles, are increasingly being equipped with driver assistance systems that, with the aid of sensor systems, are able to capture the environment, recognize traffic situations and assist the driver, for example by braking or steering intervention or by outputting an optical or acoustic warning. Radar sensors, lidar sensors, camera sensors, ultrasonic sensors or the like are normally used as sensor systems for detecting the environment. Insights about the environment can then be obtained from the sensor data determined by the sensors. The detection of the environment by means of radar sensors is based on the emission of bundled electromagnetic waves and the reflection thereof, e.g. by other road users, obstacles on the roadway or the buildings on the edge of the roadway. The detection of pedestrians is often carried out with camera sensors, but radar sensors are also increasingly being used in this respect.

The radar sensors used for systems of the type described above are also often used in combination with sensors based on other technologies, such as camera or lidar sensors. One of the advantages of radar sensors is that they operate reliably even in bad weather conditions and can measure not only the distance of objects but also their radial relative speed directly by way of the Doppler effect. Usually, 24 GHZ, 77 GHZ and 79 GHz are used as transmission frequencies, but also other permissible frequencies will be used in the future. Owing to the increasing functional scope of such systems, the requirements, in particular with regard to the maximum detection range and the performance of the environmental classification, are constantly increasing. In addition to the detection of the environment surrounding motor vehicles for systems of the type described above, the focus is now also comprising the interior monitoring of motor vehicles, e.g. to detect which seats in the vehicle are occupied; frequencies in the 60 GHz range, for example, are used here.

The classification of the detected objects is of particular importance in modern radar sensors. For example, the classification of vehicles is made primarily on the basis of the measured dimension and reflectance of the observed or detected vehicle. In this context, for example, relatively large vehicles, such as for example trucks or vans, generate multiple or a comparatively large number of reflections in the sensor image. However, the actual extent of a vehicle cannot be clearly determined. For example, it cannot be established with certainty whether the detections involve a truck with a trailer or two passenger motor vehicles (cars) traveling at a short distance and at the same speed. This can result in an incorrect classification with adverse effects on different driving functions (control strategy, HMI presentation, etc.), with the result that the performance can be restricted and the acceptance by the vehicle user can be reduced. Therefore, in the case of radar sensors and radar detection methods, there is particular interest in correctly and robustly classifying the different vehicle types, such as passenger cars and trucks, wherein the different reflections from a single vehicle should be better grouped so that they produce a correct dimension. Furthermore, it should be made possible for a correct representation of the road user to be provided on a display of the sensor vehicle (e.g. Human-Machine Interface; HMI) and that an appropriate control strategy can be implemented for various driving functions (e.g. ACC or EBA).

### PUBLISHED PRIOR ART

US 2016 284 213 A1, incorporated herein by reference, discloses a radar device that, during operation, determines, on the basis of a power value for the direction correlation and of the normalized direction correlation value, whether a detected object is a traveling vehicle. In this case, the determination of a vehicle type with a rough subdivision into trucks or passenger cars is provided by examining the properties of an echo signal component of a rotating wheel of the vehicle, using a combination of frequency shift and signal strength of the received signals. The subdivision is made based on the fact that reflections from the wheel front side (at the height of the axis of rotation) have only a small frequency shift in the vehicle longitudinal direction on account of the low speed component of the rotating wheel, while having a high signal strength on account of the reflection on an almost perpendicular surface. Reflections on the upper side of the wheel, on the other hand, have a high frequency shift owing to a high speed component of the rotating wheel in the vehicle longitudinal direction but a low signal strength due to the reflection on an almost horizontal surface, since reflections occur primarily from small vertical regions of the tire profile.

### SUMMARY OF THE INVENTION

Proceeding from the prior art, an aspect of the invention is a generic environmental sensor for object detection, in particular a radar sensor, with which an improvement in the object classification can be achieved in a simple and cost-effective manner.

In the method for object classification according to an aspect of the invention for an environmental sensor for environmental detection (in particular a radar sensor, lidar sensor, camera sensor or ultrasonic sensor for a vehicle), the environmental sensor initially emits signals which are reflected by objects and received again by the environmental sensor. The object is a target vehicle that is to be classified. To this end, a main speed of the target vehicle is determined on the basis of the signals, and speeds are determined based on signals reflected on at least one wheel rim (i.e. also on multiple wheel rims) of the target vehicle. From the determined speeds, a dispersion of the speeds resulting from the deviation of the determined speeds from the main vehicle speed is determined. Furthermore, a ratio of the wheel rim diameter to the wheel diameter is determined on the basis of the dispersion, and this ratio is used for the object classification of the target vehicle.

The method is advantageously based on a speed measurement or radial speed measurement, wherein this can be determined by means of the Doppler effect. This is an independent method which makes it possible to improve the robustness and performance of modern radar sensors. Furthermore, the object classification can be improved thereby to a particular extent.

The ratio is preferably determined by forming the quotient of wheel diameter divided by wheel rim diameter.

According to a preferred configuration of an aspect of the invention, a limit value for the ratio can be defined.

Expediently, the target vehicle can be classified as a passenger car if the dispersion of the speeds of at least one wheel of the target vehicle is lower than the limit value and/or the target vehicle can be classified as a truck if the dispersion of the speeds of at least one wheel of the target vehicle is greater than the limit value.

In addition, the method can also be applied to vehicle classes other than trucks/passenger cars, such as motorcycles, scooters, quads, e-scooters, bicycles, SUV, vans, transporters, agricultural vehicles and the like. In particular, for this purpose it is possible to define (for example previously empirically determined) limit values for the respective ratios of wheel rim diameter to wheel diameter and also for the associated dispersions, such that all vehicle classes can be classified.

Further, the reflectance of the reflected signals can be analyzed in parallel or additionally (e.g. by means of the radar cross section RCS), and this can be used additionally for the object classification of the target vehicle. In this way, an additional parameter can be provided which verifies the previously determined result or object classification, i.e. a type of check is performed, whereby the object classification can be improved even further.

Expediently, a measured dimension of the target vehicle can also be analyzed in parallel or in addition, so that it can be used in addition for the object classification of the target vehicle.

Furthermore, an aspect of the invention also relates to an environmental sensor, in particular a radar sensor (or also a lidar sensor, camera sensor or ultrasonic sensor) for object identification or environmental detection for a vehicle, the sensor data of which are used to perform an object classification, wherein the object classification is performed on the basis of the method according to an aspect of the invention.

In addition, an aspect of the present invention claims a vehicle which has an environmental sensor according to an aspect of the invention, in particular a radar sensor.

### BRIEF DESCRIPTION OF THE DRAWINGS

Aspects of the invention are described in more detail below on the basis of advantageous exemplary embodiments. In particular:

FIG. 1 shows a simplified schematic illustration of the dispersion of the wheel reflections in the case of a wheel with a large rim diameter in relation to the wheel diameter (left) and in the case of a wheel with a rim diameter that is small in relation to the wheel diameter (right);

FIG. 2 shows a simplified schematic illustration of a wheel of a passenger car having a rim diameter that is large in relation to the wheel diameter (top) and of a wheel of a truck having a rim diameter that is small in relation to the wheel diameter (bottom);

FIG. 3 shows a simplified schematic illustration of the wheels from FIG. 2, wherein their dispersion or the speed spread is independent of the wheel dimension or the wheel diameter, and

FIG. 4 shows a simplified illustration of an embodiment of a vehicle according to an aspect of the invention.

### DETAILED DESCRIPTION OF EXEMPLARY EMBODIMENTS

The presented method for classifying objects is based substantially on a speed analysis of the reflections that deviate from the main vehicle speed Vᵥₑₕ. The strength of the radar signal is therefore used to carry out a classification by way of the Doppler effect. In the case of a motor vehicle, these deviating speeds arise in particular mainly from the rotating metal rims of the wheels. For a given main vehicle speed Vᵥₑₕ, the dispersion σₛ of the deviating speeds depends directly on the ratio s of the metal rim diameter d_{Felge} to the wheel diameter d_{Rad}, where the following applies:

$$s = \frac{{d}_{Rad}}{{d}_{Felge}}$$

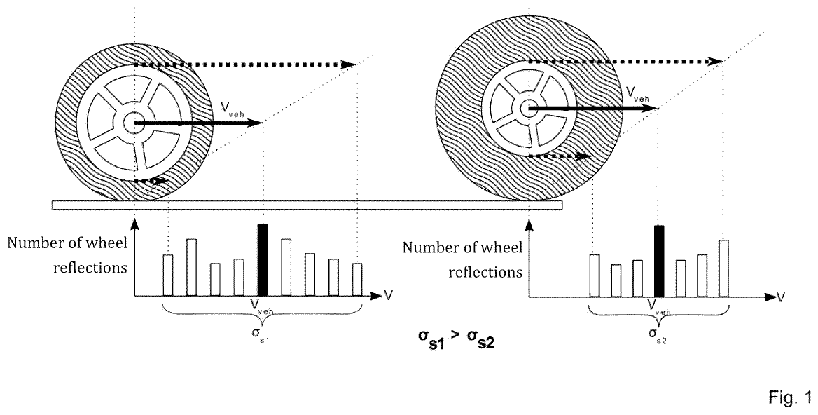

When calculating the respective dispersion σₛ, Or σₛ₁, of the detected main vehicle speed Vᵥₑₕ of a passenger car and the dispersion σₛ₂ of the detected main vehicle speed Vᵥₑₕ of a truck, the following relationship, which is relevant to object classification, can apply, as illustrated in FIG. 1:

$${σ}_{s 1} > {σ}_{s 2}$$

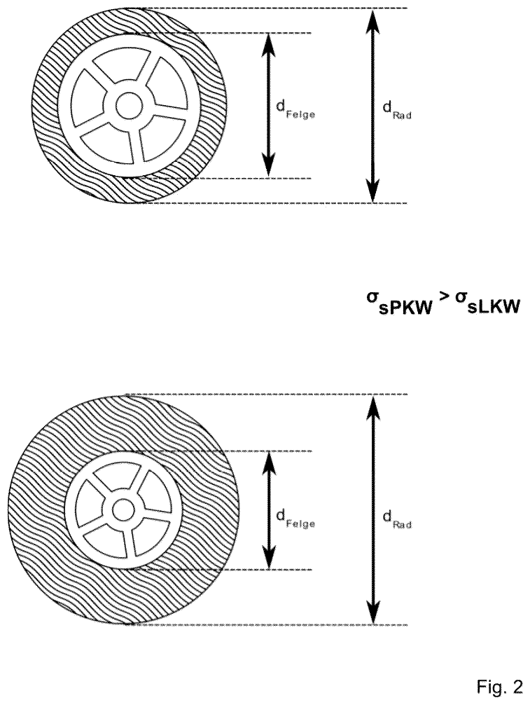

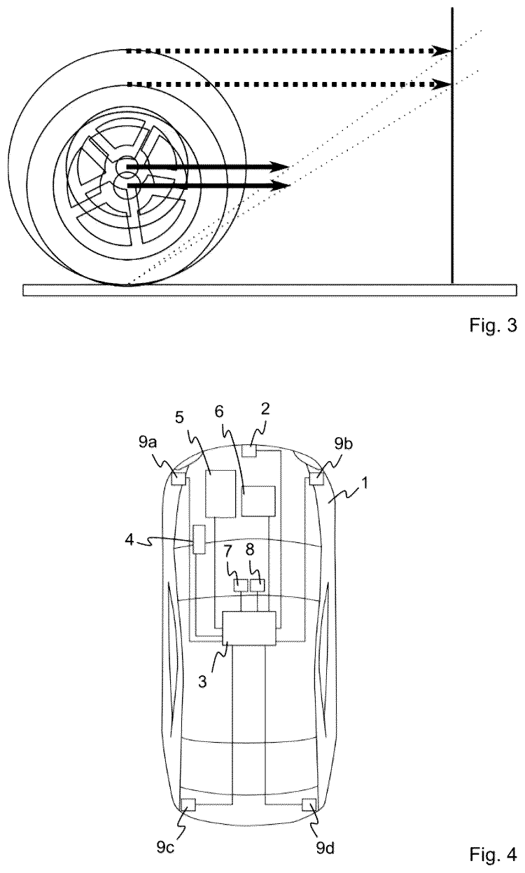

However, the dispersion or spread of the speed should be independent of the wheel dimension or wheel diameter and depend only on the relative size of the rim (i.e. the reflective part) and the tire, as shown in FIG. 2. For example, trucks generally have smaller rims in relation to the wheel diameter (rim diameter with respect to the value of the total wheel diameter) and therefore a lower dispersion σ_{sLKW} than a passenger car, σ_{sPKW}, as shown in FIG. 3, so that the following relationship applies:

$$\frac{{d}_{Rad}}{{d}_{Felge}} = {s}_{PKW} < {s}_{LKW} = \frac{{d}_{Rad}}{{d}_{Felge}}$$

$$such that$$

$${σ}_{sPKW} > {σ}_{sLKW}$$

This relationship can, of course, be applied to all vehicle classes that differ in a rim-to-wheel ratio in a corresponding, characteristic or classification-relevant manner.

Advantageously, the logic or the method can be additionally refined or improved by a parallel or additional RCS (radar cross section=reflectance) analysis of the individual wheel reflections. Advantageously, the logic or the method can be additionally refined or improved by means of a parallel or additional analysis of the geometrical dimension of the target vehicle.

In addition, the method can also be applied to other sensor technologies that detect the metal rims, such as for example ultrasound.

FIG. 4 shows a vehicle 1 according to an aspect of the invention, which has a radar sensor 2 according to an aspect of the invention for object detection or environmental detection. In this case, reference numeral 2 denotes a control device (ECU, electronic control unit or ADCU, assisted and automated driving control unit) by means of which sensor control, sensor data combination, environment and/or object recognition, trajectory planning and/or vehicle control can be carried out, in particular (partially) autonomously. For vehicle control, the control device 3 can access different actuators (steering system 4, motor 5, brake 6). In addition to the radar sensor 2, the vehicle 1 also has further sensors (lidar sensor 7, camera 8 and radar sensors 9a-9d) for environmental detection. The sensor data can advantageously be used to detect the environment and objects, such that various assistance functions, such as emergency brake assist (EBA), adaptive cruise control (ACC), lane keeping or lane keep assist (LKA) or the like, can be implemented. In addition, the assistance functions can likewise be executed by means of the control device 3 or another control unit provided for this purpose.

### LIST OF REFERENCE NUMERALS

1 vehicle
2 radar sensor
3 control device
4 steering system
5 motor
6 brake
7 lidar sensor
8 camera
9a-9d radar sensor

1. A method for object classification for an environmental sensor for detecting the environment, wherein
the environmental sensor emits signals which are reflected by objects and received again by the environmental sensor, wherein
the object is a target vehicle,
a main speed (Vᵥₑₕ) of the target vehicle is determined on the basis of the signals, and
speeds are determined for signals reflected on at least one wheel rim of the target vehicle, wherein
a dispersion (σₛ) is determined on the basis of the speeds, which dispersion results from the deviation of the determined speeds from the main vehicle speed (Vᵥₑₕ), and
a ratio (s) of wheel rim diameter (d_{Felge}) to wheel diameter (d_{Rad}) is determined on the basis of the dispersion (σₛ), wherein
the ratio (s) is used for the object classification of the target vehicle.

2. The method according to claim 1, wherein the ratio (s) is determined by forming the quotient of wheel diameter (d_{Rad}) divided by wheel rim diameter (d_{Felge}).

3. The method according to claim 1, wherein a limit value is defined for the ratio (s).

4. The method according to claim 3, wherein the target vehicle is classified as a passenger car if the dispersion (σs) of the speeds of at least one wheel of the target vehicle is lower than the limit value and/or the target vehicle is classified as a truck if the dispersion (σs) of the speeds of at least one wheel of the target vehicle is greater than the limit value.

5. The method according to claim 1, wherein the reflectance of the reflected signals is analyzed in parallel or in addition and it is additionally used for the object classification of the target vehicle.

6. The method according to claim 1, wherein a measured dimension of the target vehicle is analyzed in parallel or in addition and is additionally used for the object classification of the target vehicle.

7. An environmental sensor, for object recognition for a vehicle, the sensor data of which are used to perform an object classification, wherein the object classification takes place by means of a method according to claim 1.

8. A vehicle, having an environmental sensor, according to claim 7.

9. The method according to claim 1, wherein the environmental sensor is a radar sensor.

10. The environmental sensor according to claim 7, wherein the environmental sensor is a radar sensor.

11. The vehicle according to claim 8, wherein the environmental sensor is a radar sensor.
